(19) United States
(12) Patent Application Publication
(10) Pub. No.: US 2025/0337295 A1
(43) Pub. Date: Oct. 30, 2025

(54) VIBRATION ISOLATOR FOR POWER TOOL CIRCUIT BOARD

(71) Applicant: MILWAUKEE ELECTRIC TOOL CORPORATION, Brookfield, WI (US)

(72) Inventors: John M. Van Treeck, Lannon, WI (US); Joseph Drees, Wauwatosa, WI (US); Benjamin J. Skelton, Milwaukee, WI (US); Jessie L. Bernitt, Milwaukee, WI (US); Mark A. Kubale, West Bend, WI (US)

(21) Appl. No.: 18/647,647

(22) Filed: Apr. 26, 2024

(51) Int. Cl. H02K 5/04; H02K 5/24; H02K 7/14

(52) U.S. Cl. CPC H02K 5/04; H02K 5/24; H02K 7/14

(57) ABSTRACT

A power tool may include a housing including a motor housing portion, a front housing portion coupled to the motor housing portion, and a handle portion extending from the motor housing portion. A power tool may include a motor supported within the motor housing portion. A power tool may include an output driven by the motor to rotate about an axis, the output extending from the front housing portion. A power tool may include an actuator supported by the handle portion and configured to control operation of the motor. A power tool may include a circuit board supported within an accommodating region between the actuator and the front housing portion. A power tool may include a vibration isolator positioned on the circuit board and between the circuit board and the housing.

### BACKGROUND

The present disclosure relates to a power tool including a circuit board.

### SUMMARY

In some aspects, the techniques described herein relate to a power tool including: a housing including a motor housing portion, a front housing portion coupled to the motor housing portion, and a handle portion extending from the motor housing portion; a motor supported within the motor housing portion; an output driven by the motor to rotate about an axis, the output extending from the front housing portion; an actuator supported by the handle portion and configured to control operation of the motor; a circuit board supported within an accommodating region between the actuator and the front housing portion; and a vibration isolator positioned on the circuit board and between the circuit board and the housing.

In some aspects, the techniques described herein relate to a power tool, wherein the vibration isolator is configured to reduce the transfer of vibration generated by operation of the power tool to the circuit board.

In some aspects, the techniques described herein relate to a power tool, wherein the vibration isolator is made of foam.

In some aspects, the techniques described herein relate to a power tool, wherein the vibration isolator is compressed between the circuit board and the housing.

In some aspects, the techniques described herein relate to a power tool, wherein the vibration isolator is adhered to the circuit board.

In some aspects, the techniques described herein relate to a power tool, wherein the circuit board includes a plurality of semi-conductor switching elements.

In some aspects, the techniques described herein relate to a power tool, wherein the circuit board extends parallel to the axis.

In some aspects, the techniques described herein relate to a power tool, wherein the actuator is a trigger movable in a direction parallel to the axis to vary an operating speed of the motor.

In some aspects, the techniques described herein relate to a power tool, wherein the housing includes cooperating clamshell halves defining the motor housing portion and the handle portion, wherein the clamshell halves define an upper wall of the accommodating region, the upper wall extending adjacent a bottom side of the front housing portion, and wherein the vibration isolator is compressed between the circuit board and the upper wall.

In some aspects, the techniques described herein relate to a power tool including: a housing including a motor housing portion, a front housing portion coupled to the motor housing portion, and a handle portion extending from the motor housing portion; a motor supported within the motor housing portion; an impact mechanism driven by the motor to deliver rotational impacts to an output extending from the front housing portion, the output being rotatable about an axis; an actuator supported by the handle portion and configured to control operation of the motor; a circuit board extending parallel to the axis, the circuit board supported within the housing and including a first side facing the impact mechanism and a second side facing the actuator; and a vibration isolator positioned on the first side of the circuit board.

In some aspects, the techniques described herein relate to a power tool, wherein the vibration isolator is configured to reduce the transfer of vibration generated by operation of the power tool to the circuit board.

In some aspects, the techniques described herein relate to a power tool, wherein the vibration isolator is made of foam.

In some aspects, the techniques described herein relate to a power tool, wherein the vibration isolator is compressed between the first side of the circuit board and the housing.

In some aspects, the techniques described herein relate to a power tool, wherein the circuit board is supported within an accommodating region between the front housing portion and the actuator.

In some aspects, the techniques described herein relate to a power tool, wherein the housing includes cooperating clamshell halves defining the motor housing portion and the handle portion, wherein the clamshell halves define an upper wall of the accommodating region, the upper wall extending adjacent a bottom side of the front housing portion, and wherein the vibration isolator is compressed between the first side of the circuit board and the upper wall.

In some aspects, the techniques described herein relate to a power tool, wherein the vibration isolator covers less than 50% of the first side of the circuit board.

In some aspects, the techniques described herein relate to a power tool including: a housing including cooperating clamshell halves defining a motor housing portion and a handle portion extending from the motor housing portion, the housing further including a front housing portion coupled to the clamshell halves; a motor supported within the motor housing portion; an output driven by the motor to rotate about an axis, the output extending from the front housing portion; an actuator supported by the handle portion and configured to control operation of the motor; a circuit board supported within an accommodating region between the actuator and the front housing portion, wherein the clamshell halves define an upper wall of the accommodating region, the upper wall extending adjacent a bottom side of the front housing portion; and a vibration isolator positioned between the circuit board and the upper wall.

In some aspects, the techniques described herein relate to a power tool, wherein the actuator is a multi-position switch.

In some aspects, the techniques described herein relate to a power tool, wherein the vibration isolator includes foam compressed between the circuit board and the upper wall.

In some aspects, the techniques described herein relate to a power tool, wherein the actuator is a trigger configured to control an operating speed of the motor.

### BRIEF DESCRIPTION OF THE DRAWINGS

FIG. 1 illustrates a perspective view of a power tool.

FIG. 2 illustrates a cut-away perspective view of the power tool of FIG. 1.

FIG. 3 illustrates a section view of the power tool of FIG. 1 along line 3-3.

FIG. 4 illustrates a close-up perspective view of a circuit board of the power tool of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

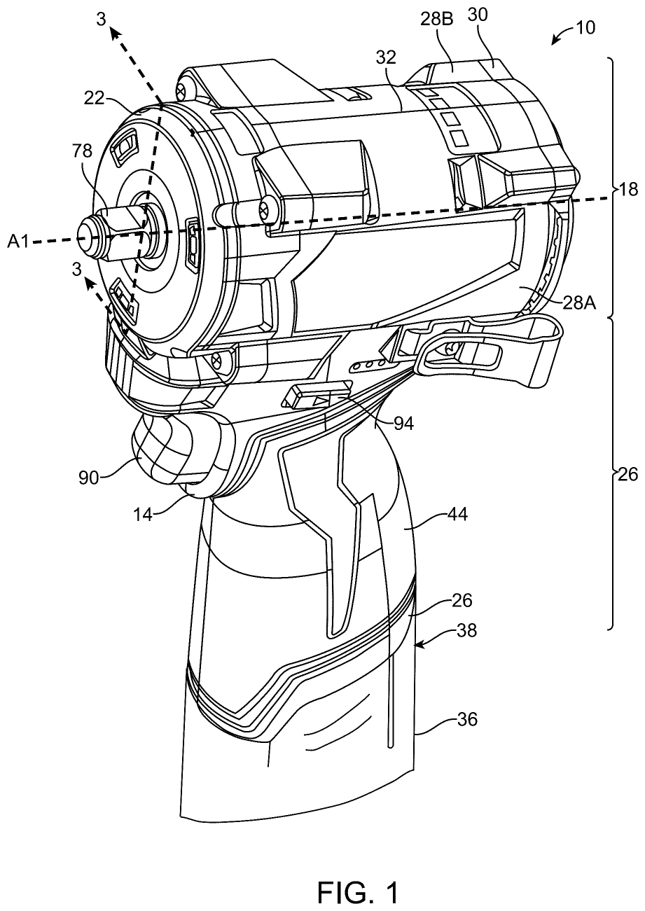

FIG. 1 illustrates an embodiment of a power tool in the form of a rotary impact tool, and, more specifically, an impact wrench 10. The impact wrench 10 includes a housing 14 with a motor housing portion 18, an impact case or front housing portion 22 coupled to the motor housing portion 18, and a handle portion 26 extending downwardly from the motor housing portion 18. In the illustrated embodiment, the handle portion 26 and the motor housing portion 18 are defined by cooperating first and second clamshell halves or housing portions 28a, 28b; however, the housing 14 may be constructed in other ways in other embodiments.

With continued reference to FIG. 1, the clamshell halves 28A, 28B are coupled (e.g., fastened) together at an interface or seam 32. The illustrated housing 14 also includes an end cap 30 coupled to the motor housing portion 18 opposite the front housing portion 22. In yet other embodiments, the impact wrench 10 may not include a separate end cap, such that the clamshell halves 28a, 28b instead define the rear end of the motor housing portion 18. In yet other embodiments, the front housing portion 22 may be omitted or may be enclosed by the clamshell halves 28a, 28b.

The illustrated impact wrench 10 includes a battery 36 removably coupled to a battery receptacle 38 in the handle portion 26. A motor 42 is supported within the motor housing portion 18 and receives power from the battery 36 via connections, pads, and/or battery terminals in the battery receptacle 38 when the battery 36 is coupled to the battery receptacle 38. In the illustrated embodiment, the handle portion 26 of the clamshell halves 28a, 28b can be covered or surrounded by a grip portion 44, which may be overmolded on the handle portion 26.

The battery 36 may be a power tool battery pack generally used to power a power tool, such as an electric drill, an electric saw, and the like (e.g., a 12 volt rechargeable battery pack). The battery 36 may include lithium ion (Li-ion) cells. The 12-volt nominal output voltage of the battery 36 provides an optimal balance between weight/size and power in the illustrated impact wrench 10; however, batteries with other nominal voltages may be used in other embodiments.

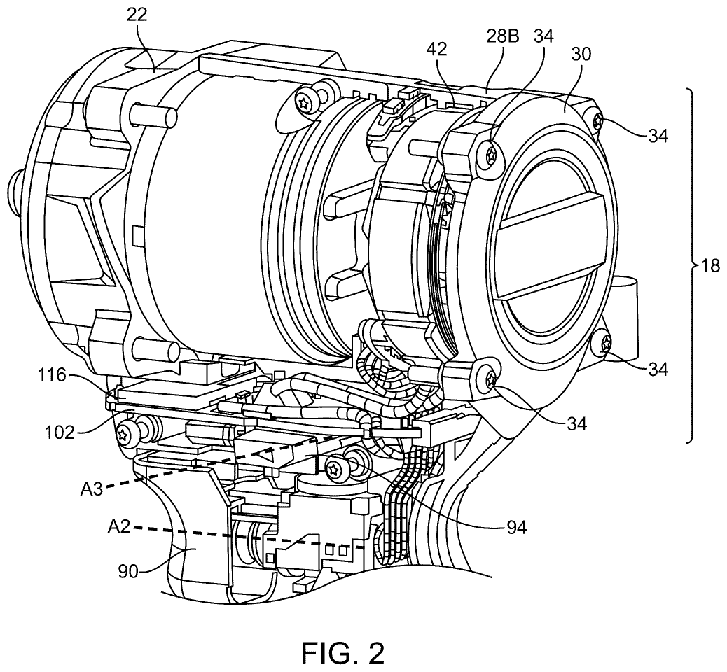

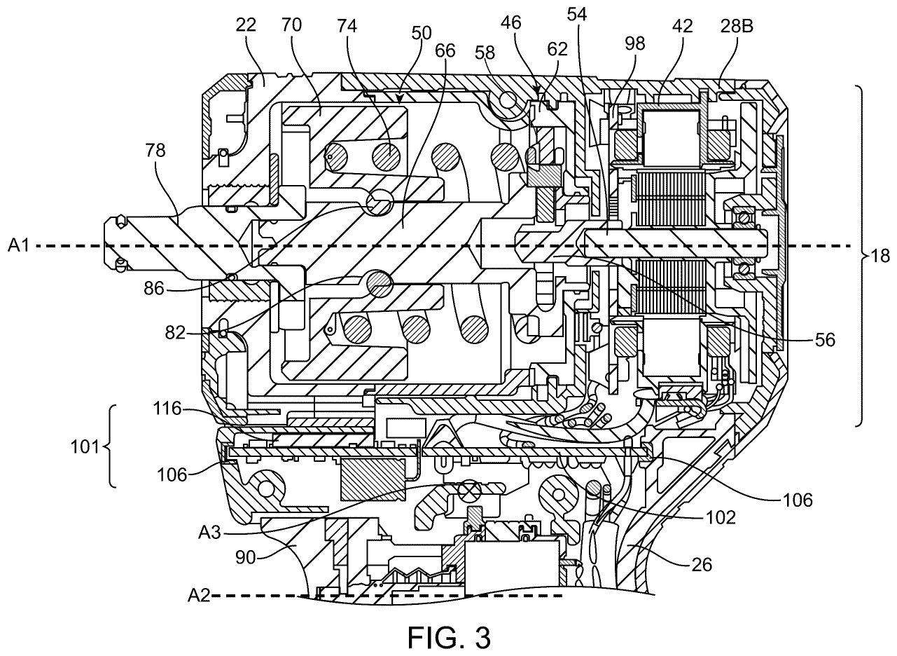

With reference to FIGS. 2-3, in the illustrated embodiment, the motor 42 is positioned within the motor housing portion 18 adjacent to the end cap 30. The illustrated motor 42 is a brushless direct current (“BLDC”) motor with a stator and a rotor or output shaft 54 that extends through the stator and is rotatable about an rotational axis A1 relative to the stator. In other embodiments, the motor 42 may be another type of motor, such as a brushed motor, an outer-rotor motor, etc.

A gear assembly 46 supported by the motor housing portion 18 receives torque from the output shaft 54 of the motor 42 and provides a speed reduction between the output shaft 54 and an impact mechanism 50 (FIG. 3). The illustrated gear assembly 46 includes a pinion gear 56 coupled to the output shaft 54 of the motor 42, a plurality of planet gears 58 meshed with the pinion gear 56, and a ring gear 62 meshed with the planet gears 58 and rotationally fixed within the motor housing portion 18. The planet gears 58 are coupled to a cam shaft 66 of the impact mechanism 50 such that the cam shaft 66 acts as a planet carrier. The illustrated ring gear 62 is directly supported by the clamshell halves 28A, 28B; however, the ring gear 62 may alternatively be supported in other ways (e.g., within a gear case).

The impact mechanism 50 is configured to convert the constant rotational force or torque provided by the motor 42 and the gear assembly 46 to a striking rotational force or intermittent applications of torque. The illustrated impact mechanism 50 includes the cam shaft 66, a hammer 70, a spring 74, and an anvil 78. The cam shaft 66 is configured to transfer rotation from the planet gears 58 to the hammer 70 and includes cam grooves 82 in which corresponding cam balls 86 are received. The hammer 70 is configured to reciprocate axially along the cam shaft 66 and impart periodic rotational impacts to the anvil 78 in response to rotation of the cam shaft 66. The spring 74 biases the hammer 70 in an axial direction toward the anvil 78, along the rotational axis A1. The anvil 78 extends from the front housing portion 22 and defines an output of the impact wrench 10 rotatable about the axis A1. The illustrated anvil 78 has a distal end or drive to which a tool element (e.g., a socket, not shown) can be coupled for performing work on a workpiece (e.g., a fastener).

Referring to FIGS. 2 and 3, the impact wrench 10 also includes a trigger 90, a multi-position switch 94, a first circuit board 98, and a second circuit board 102. The trigger 90 and the multi-position switch 94, which may also be referred to as actuators, are supported by the handle portion 26 of the housing 14 and are configured to control operational characteristics of the motor 42 based on user input. Specifically, the trigger 90 is movable along a trigger axis A2, parallel to the rotational axis A1, by a user to energize and de-energize the motor and, in some embodiments, to control a rotational speed of the motor 42 (e.g., proportional to the movement of the trigger 90 along the trigger axis A2). The multi-position switch 94 is movable to a plurality of positions along a multi-position switch axis A3, orthogonal to both the rotation axis A1 and the trigger axis A2, by a user to control the desired direction of rotation of the motor 42.

In the illustrated embodiment, the first circuit board 98 is supported within the motor housing portion 18 adjacent a front end of the motor 42. The illustrated first circuit board 98 extends perpendicular to the rotational axis A1 and includes one or more Hall-Effect sensors, which provide feedback for controlling the motor 42. In some embodiments, the first circuit board 98 may be omitted, and the motor 42 may be configured for sensor-less control via the second circuit board 102.

Referring to FIG. 3, the second circuit board 102 extends parallel to the rotation axis A1 and is positioned in an accommodating region 101 between an upper end of the handle portion 26 and a bottom side of the front housing portion 22 (and between the trigger 90 and the front housing portion 22 in the illustrated embodiment). In the illustrated embodiment, the circuit board 102 is held in a plurality of recesses 106 formed on an inner surface of each the clamshell halves 28A, 28B. The recesses 106 support the second circuit board 102 and limit motion of the second circuit board 102 in a direction parallel to the rotational axis A1. The second circuit board 102 is in electrical communication with the motor 42, the trigger 90, and the terminals (not shown) of the battery receptacle 38. In the illustrated embodiment, the second circuit board 102 includes a plurality of semi-conductor switching elements (e.g., MOSFETs, IGBTs, or the like), one or more microprocessors, machine-readable, non-transitory memory elements, and other electrical or electronic elements for providing operational control to the impact wrench 10. Additionally, the second circuit board 102 may be at least partially encased in a potting material (i.e., clear epoxy polymer) applied to select regions or select electrical or electronic elements.

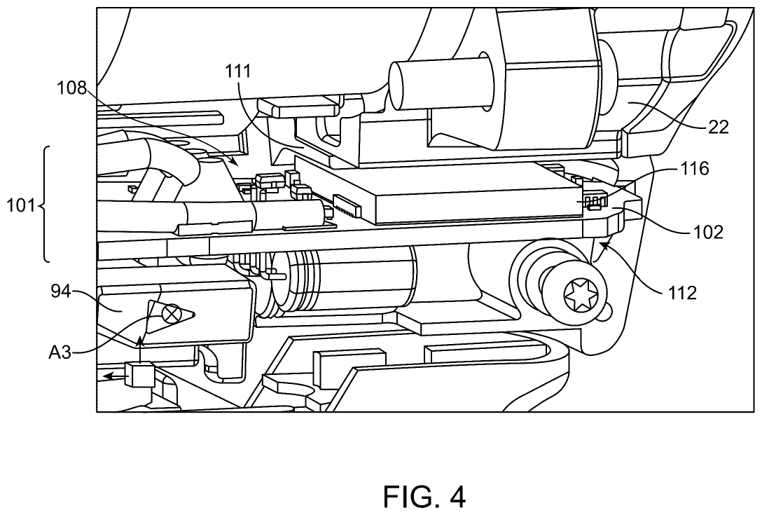

As shown in FIG. 4, the second circuit board 102 further includes a first side 108 facing the impact mechanism 50 and a second side 112 facing the multi-position switch 94. The A vibration isolator 116 is provided on the first side 108 of the second circuit board 102. The illustrated vibration isolator 116 is made of a non-conductive elastomer (e.g., foam, rubber, or silicone) and is adhesively joined to the first side 108. The vibration isolator 116 fills a gap between the first side 108 of the second circuit board 102 and an upper wall 111 of the accommodating region 101, which in the illustrated embodiment extends adjacent the bottom side of the front housing portion 22. In some embodiments, the vibration isolator 116 may be compressed between the upper wall 111 and the second circuit board 102, such that the vibration isolator 116 may bias the second circuit board 102 towards the multi-position switch 94.

In operation, the cam balls 86 are in driving engagement with the hammer 70 and movement of the cam balls 86 within the cam grooves 82 allows for relative axial movement of the hammer 70 along the cam shaft 66 when the hammer 70 and the anvil 78 are engaged and the cam shaft 66 continues to rotate. The axial movement of the hammer 70 compresses the spring 74, which, upon retraction of the hammer 70 a sufficient distance to clear the anvil 78, then releases its stored energy to propel the hammer 70 forward and rotate the hammer 70. The hammer 70 then strikes the anvil 78 to deliver torque to the anvil 78, and the process repeats.

The elastic properties of the vibration isolator reduces the transfer of vibration in an axis orthogonal to the rotational axis A1 generated by the impact mechanism 50 during operation of the impact wrench 10. The pressure exerted on the second circuit board 102 by the vibration isolator 116 may also reduce any oscillations of the circuit board 102 that may be caused by such vibration. By limiting the exposure of the second circuit board 102 to vibration, the impact wrench 10 may have a longer life span. In the illustrated embodiment, the vibration isolator 116 covers a surface area less than 50% of the total surface area of the second circuit board 102 and is only positioned on the first side 108. In other embodiments, the vibration isolator 116 may cover a larger portion of the second circuit board 102 and may be directly attached to the electrical or electronic elements of the second circuit board 102. Furthermore, in other embodiments, both the first and second sides 108, 112 or only the second side 112 may include vibration isolators 116 adhered to the second circuit board 102 and in contact with a portion of the housing 14.

Various features and aspects of the present disclosure are set forth in the following claims.

What is claimed is:

1. A power tool comprising:
a housing including a motor housing portion, a front housing portion coupled to the motor housing portion, and a handle portion extending from the motor housing portion;
a motor supported within the motor housing portion;
an output driven by the motor to rotate about an axis, the output extending from the front housing portion;
an actuator supported by the handle portion and configured to control operation of the motor;
a circuit board supported within an accommodating region between the actuator and the front housing portion; and
a vibration isolator positioned on the circuit board and between the circuit board and the housing.

2. The power tool of claim 1, wherein the vibration isolator is configured to reduce the transfer of vibration generated by operation of the power tool to the circuit board.

3. The power tool of claim 1, wherein the vibration isolator is made of foam.

4. The power tool of claim 1, wherein the vibration isolator is compressed between the circuit board and the housing.

5. The power tool of claim 1, wherein the vibration isolator is adhered to the circuit board.

6. The power tool of claim 1, wherein the circuit board includes a plurality of semi-conductor switching elements.

7. The power tool of claim 1, wherein the circuit board extends parallel to the axis.

8. The power tool of claim 1, wherein the actuator is a trigger movable in a direction parallel to the axis to vary an operating speed of the motor.

9. The power tool of claim 1, wherein the housing includes cooperating clamshell halves defining the motor housing portion and the handle portion, wherein the clamshell halves define an upper wall of the accommodating region, the upper wall extending adjacent a bottom side of the front housing portion, and wherein the vibration isolator is compressed between the circuit board and the upper wall.

10. A power tool comprising:
a housing including a motor housing portion, a front housing portion coupled to the motor housing portion, and a handle portion extending from the motor housing portion;
a motor supported within the motor housing portion;
an impact mechanism driven by the motor to deliver rotational impacts to an output extending from the front housing portion, the output being rotatable about an axis;
an actuator supported by the handle portion and configured to control operation of the motor;
a circuit board extending parallel to the axis, the circuit board supported within the housing and including a first side facing the impact mechanism and a second side facing the actuator; and
a vibration isolator positioned on the first side of the circuit board.

11. The power tool of claim 10, wherein the vibration isolator is configured to reduce the transfer of vibration generated by operation of the power tool to the circuit board.

12. The power tool of claim 10, wherein the vibration isolator is made of foam.

13. The power tool of claim 10, wherein the vibration isolator is compressed between the first side of the circuit board and the housing.

14. The power tool of claim 10, wherein the circuit board is supported within an accommodating region between the front housing portion and the actuator.

15. The power tool of claim 14, wherein the housing includes cooperating clamshell halves defining the motor housing portion and the handle portion, wherein the clamshell halves define an upper wall of the accommodating region, the upper wall extending adjacent a bottom side of the front housing portion, and wherein the vibration isolator is compressed between the first side of the circuit board and the upper wall.

16. The power tool of claim 10, wherein the vibration isolator covers less than 50% of the first side of the circuit board.

17. A power tool comprising:
a housing including cooperating clamshell halves defining a motor housing portion and a handle portion extending from the motor housing portion, the housing further including a front housing portion coupled to the clamshell halves;
a motor supported within the motor housing portion;
an output driven by the motor to rotate about an axis, the output extending from the front housing portion;
an actuator supported by the handle portion and configured to control operation of the motor;
a circuit board supported within an accommodating region between the actuator and the front housing portion, wherein the clamshell halves define an upper wall of the accommodating region, the upper wall extending adjacent a bottom side of the front housing portion; and
a vibration isolator positioned between the circuit board and the upper wall.

18. The power tool of claim 17, wherein the actuator is a multi-position switch.

19. The power tool of claim 17, wherein the vibration isolator includes foam compressed between the circuit board and the upper wall.

20. The power tool of claim 17, wherein the actuator is a trigger configured to control an operating speed of the motor.
